(19) United States
(12) Patent Application Publication
(10) Pub. No.: US 2017/0322545 A1
(43) Pub. Date: Nov. 9, 2017

(54) OPERATING METHOD FOR A METALLURGICAL PLANT WITH OPTIMIZATION OF THE OPERATING MODE

(71) Applicant: Primetals Technologies Austria GmbH, Linz (AT)

(72) Inventors: Paul FISCHER, Linz (AT); Franz HARTL, Kallham (AT); Eberhard KARNITSCH-EINBERGER, Linz (AT); Thomas KUEHAS, Luftenberg (AT); Andreas ROHRHOFER, Linz (AT); Werner SCHWARZ, Lambrechten (AT); Klaus STOHL, Gramastetten (AT); Michael WEINZINGER, Neuhofen a. d. Krems (AT)

(21) Appl. No.: 15/532,542

(22) PCT Filed: Aug. 27, 2015
(86) PCT No.: PCT/EP2015/069583

§ 371 Date: Jun. 2, 2017

(30) Foreign Application Priority Data
Dec. 17, 2014 (EP) 14198458.3

(51) Int. Cl. G05B 19/418

(52) U.S. Cl. CPC G05B 19/418; G05B 2219/40336

(57) ABSTRACT

Controlling a metallurgical plant, the plant has at least one plant part (1) operated with first and second operating parameters (BP 1, BP2) at a particular time, and an operating result (BE) is established on the basis of the operation of the plant part (1) according to the first and second operating parameters (BP1, BP2). The operating result (BE) is recorded. At least the operating result (BE) is transmitted from a control device (5) of the first plant part (1) to a computing unit (9). The computing unit (9) varies the second operating parameters (BP2), but not the first operating parameters (BP1), and thereby determines varied second operating parameters (BP2′) associated with the first operating parameters (BP 1). The computing unit (9) transmits the varied second operating parameters (BP2′) back to the control device (5) of the first plant part (1). The control device (5) of the first plant part (1) uses the varied second operating parameters (BP2′), after the transmission of the varied second operating parameters (BP2′), when the first operating parameters (BP1) are established.

### CROSS-REFERENCE TO RELATED APPLICATIONS

The present application is a 35 U.S.C. §§371 national phase conversion of PCT/EP2015/069583, filed Aug. 27, 2015, which claims priority of European Patent Application No. 14198458.3, filed Dec. 17, 2014, the contents of which are incorporated by reference herein. The PCT International Application was published in the German language.

### TECHNICAL FIELD

The present invention is directed to an operating method for a metallurgical plant comprising at least one first plant part,
wherein the first plant part is operated with the aid of first and second operating parameters at a certain point in time,
wherein an operating result, which was established on the basis of the operation of the first plant part according to the first and second operating parameters, is recorded.

### TECHNICAL BACKGROUND

Metallurgical plants are generally operated as closed units from an automation perspective. The particular plant is installed for the customer, which is a plant operator, by the plant manufacturer, is optimized during the start-up, and is then handed off to the customer. After the hand-off to the customer, either no further optimization of the operation of the metallurgical plant takes place, or such an optimization takes place after a period of several years, when the plant undergoes maintenance as a whole and is reconditioned in general.

In the prior art, there is generally no contact between the manufacturer and the operator of the metallurgical plant during the ongoing operation of the metallurgical plant. In the event of a problem, it is possible that the plant operator takes it upon himself to transmit measured values to the manufacturer and request the manufacturer for an evaluation. Such an evaluation and analysis takes a long time, however. Often, a personal trip by specialists to the metallurgical plant is even required. This procedure is therefore highly complicated in practice and is therefore often not implemented.

The operation of metallurgical plants or their plant parts, such as, for example, blast furnace, electric arc furnace, steel mill, sintering plant, continuous casting plant, etc., generally takes place in a highly automated manner. Each particular plant part is controlled by a particular control unit which operates the particular plant part according to a particular operating diagram. The operating diagram establishes the operating mode and, more specifically, the sequence of the individual operating modes of the particular plant part. Every individual operating state of the particular plant part is characterized by a number of operating parameters. Many of these operating parameters are established according to the desired operation of the particular plant part. In the case of an electric arc furnace, the intention is to produce steel having a certain composition, for example. In the case of a vacuum treatment plant, the intention is to influence the composition of the steel in a targeted manner, for example. Such operating parameters are first operating parameters within the scope of the present invention. Other ones of these operating parameters can be varied freely or within certain limits. In the case of an electric arc furnace, the electrode spacing and the operating voltage or the operating current can be adjusted, for example. The duration of the melt phases is coupled to the operating voltage and the operating current. Such operating parameters are second operating parameters within the scope of the present invention. The operating diagram includes particular groups of operating parameters, which in combination define a particular operating mode of the particular plant part. Each group of operating parameters comprises the associated first and second operating parameters. The groups of operating parameters can form a state sequence—for example as a time diagram or as a simple sequence without an assignment of fixed times—or a simple list.

The operating mode according to the prior art results in correct results in practice during the operation of the plant. In this context, “correct” means that the desired product is produced by means of the particular metallurgical plant and that technical constraints that absolutely must be met, such as environmental regulations, for example, are met. The procedure according to the prior art does not always result in an optimal operating mode of the metallurgical plant, however, in particular when external circumstances change dynamically.

It is known to collect process data and measurement data on the metallurgical plant and to forward said data to an external computing unit if necessary. There, the transmitted data are evaluated intellectually by a person or in an automated manner by the computing unit. On the basis of the evaluation, a report is compiled and transmitted to the plant operator. A direct process-influencing transmission of data to the control unit of the metallurgical plant (or a plant part) is not common, however. It is known, however, that multiple setpoint value sets are stored within the control unit of the metallurgical plant (or a plant part), one of said setpoint value sets being selected by the operating personnel in each case.

### SUMMARY OF THE INVENTION

The problem addressed by the present invention is that of creating possibilities for continuously optimizing the operation of the metallurgical plant.

According to the invention, an operating method of the type mentioned at the outset is designed in such a way that
at least the operating result is transmitted from a control unit of the first plant part to a computing unit,
the computing unit varies the second operating parameters, but not the first operating parameters, and thereby determines varied second operating parameters associated with the first operating parameters,
the computing unit transmits the varied second operating parameters back to the control unit of the first plant part, and
the control unit of the first plant part uses the varied second operating parameters, after the transmission of the varied second operating parameters, when the first operating parameters are established.

The type of data transmission between the control unit of the first plant part and the computing unit can be wired or wireless, as necessary.

Due to the procedure according to the invention, it is possible to continuously adapt the operation of the first plant part to changing circumstances and to continuously optimize the operation. The optimization can take place with respect to different aspects. In particular, it is possible to carry out the operation of the first plant part with respect to a minimization of the energy requirement, the CO2 emissions, the generation of by-products or waste products, or with respect to the demand for raw materials or, generally, with respect to the operating costs. Combinations of these criteria are also possible.

Preferably, it is provided that the computing unit determines the varied second operating parameters on the basis of a model of the first plant part with consideration for the first operating parameters and/or the second operating parameters and with consideration for the operating result. A particularly reliable prediction of the operating result that will be obtained by varying the second operating parameters can therefore take place.

It is possible that the first operating parameters and/or the second operating parameters are known a priori to the computing unit. Alternatively, it is possible that the aforementioned operating parameters are transmitted from the control unit of the first plant part to the computing unit.

The computing unit generally carries out an optimization of the second operating parameters. For example, it is possible that the computing unit applies at least the second operating parameters in a cost function and determines the varied second operating parameters by way of an optimum of the cost function being reached with respect to the correspondingly varied second operating parameters. The operating result can be taken into account by way of the computing unit applying the first and second operating parameters in the model and thereby determining an associated expected operating result and, within the scope of the optimization of the cost function, accounting for constraints to be met for the operating result and/or also applying the expected operating result in the cost function. The optimization can be, for example, in the end, a cost optimization, for example, by optimizing the energy consumption or the raw material usage.

In such a case, changes can also result, for example, by varying the cost function per se. For example, if the costs for alternatively usable raw materials (which correspond to the second operating parameters in this case) change, an optimum of the raw material mixture can change, under certain circumstances. Similar comments apply for the case in which the costs for the use of by-products or the disposal of waste products change. Alternatively, changes can result, for example, by varying the model per se. If a modified model does a better job of modeling the real first plant part, an improved determination of the second operating parameters can also take place. It is also possible that constraints that must be met—for example, environmental regulations—change and, therefore, another optimization of the second operating parameters can, should, or must take place.

The recording of the operating results and, if necessary, the first and second operating parameters by the control unit of the first plant part preferably takes place continuously. The transmission of the aforementioned quantities to the computing unit can also take place continuously. Alternatively, the transmission can take place discontinuously. In the latter case, the control unit of the first plant part buffers the recorded operating results and, if necessary, the first and second operating parameters, until a transmission to the computing unit takes place.

Conversely, the control unit of the first plant part initially merely receives varied second operating parameters transmitted thereto and buffers said parameters. As a result, it can be achieved, in particular, that the varied second operating parameters are progressively transmitted in multiple packets to the control unit of the second plant part. An application in the sense that the control unit actually uses the received and buffered varied second operating parameters, however, takes place only when the varied second operating parameters have been completely and correctly transmitted to the control unit.

Preferably, the control unit of the first plant part checks the buffered second operating parameters for plausibility. The control unit of the first plant part acquires the buffered second operating parameters as new second operating parameters provided the buffered second operating parameters pass the plausibility check. Otherwise, said control unit discards the buffered second operating parameters and therefore continues to use the previously valid second operating parameters. By means of this procedure, it is ensured, in particular, that a correct operation of the metallurgical plant is maintained by the computing unit even in the case of a faulty determination of the varied second operating parameters.

The plausibility check can be designed as needed. In the simplest case, the plausibility check involves checking whether an evaluation of the buffered second operating parameters from the second operating parameters lies within a predefined boundary.

The predefined boundary can be known to the computing unit. In the sense of an optimization of the second operating parameters, if a variation of the second operating parameters by more than the predefined boundary is required, such a variation can be implemented by varying the second operating parameters in intermediate steps.

The operating result is recorded over and over again. Preferably, the entire sequence of the recorded operating results is transmitted to the computing unit. Within the scope of the transmission, if the first and/or second operating parameters are also transmitted to the computing unit, this also applies for the sequence of the first and/or second operating parameters.

In addition, the control unit outputs the particular current second operating parameters (and, possibly, also the particular current first operating parameters) with a control pulse, in each case, to controlled elements of the first plant part. Preferably, the control unit of the first plant part records at least the operating result with the control pulse or a whole-number multiple of the control pulse.

Preferably, not only does the recording of the operating results and the first and second operating parameters take place continuously, but so does the transmission of the operating results and, if required, the first and/or second operating parameters to the computing unit. The transmission of the varied second operating parameters to the control unit of the first plant part, however, can take place in a longer time interval.

The time interval between each re-transmission of the varied second operating parameters can be between several hours and several months, as necessary. The time interval is often between 2 days and 30 days, preferably between 5 days and 10 days, in particular 6 days to 8 days. The transmission of the varied second operating parameters can take place in irregular time intervals, in particular.

The control unit of the first plant part and the computing unit preferably communicate with one another via a non-proprietary universal data link. A “non-proprietary universal data link” means that the data link is not configured to be dedicated for the two components, but rather is generally established and can also be utilized by any other units. Examples of corresponding data links are the public telephone network, mobile communication networks for telephone and/or data (examples: GSM standard or UTMS standard), a LAN, a WLAN, a Bluetooth connection and, in particular, the Internet.

The first plant part can be designed as needed. For example, it is possible that the first plant part is an electrostatic dust filter comprising several successively connected filter chambers. In this case, a dust-laden exhaust gas is fed to the electrostatic dust filter, is dedusted in the filter chambers, and is given off by the electrostatic dust filter as purified exhaust gas. The first operating parameter in this case is either the operating state of an assembly located upstream from the electrostatic dust filter, or a volumetric flow and/or extent of loading of the dust-laden exhaust gas fed to the electrostatic dust filter. The second operating parameters in this case are electrical quantities of the individual filter chambers of the electrostatic dust filter. The operating result in this case is the purity level of the purified exhaust gas.

The metallurgical plant often comprises a second plant part in addition to the first plant part. In this case, it is possible, of course, to also carry out an operating method according to the invention for the second plant part of the metallurgical plant. It is also possible that the first and the second plant parts are decoupled from each other.

Alternatively, it is possible that the two plant parts are coupled to each other in such a way that an output product of the first plant part is an input product of the second plant part. The control unit of the second plant part is a different unit than the control unit of the first plant part. The computing unit for determining the varied second operating parameters for the first plant part, however, is preferably identical to the computing unit for determining the varied second operating parameters for the second plant part. As a result, it is possible to carry out a joint optimization of the second operating parameters for the two plant parts. The corresponding procedure can also be expanded to more than two plant parts, of course.

The above-described properties, features, and advantages of this invention and the manner in which they are achieved will become clearer and easier to understand in conjunction with the following description of the exemplary embodiments which are described in greater detail in combination with the drawings. In a schematic representation:

### BRIEF DESCRIPTION OF THE DRAWINGS

FIG. 1 schematically shows a metallurgical plant,

FIG. 2 schematically shows an electrostatic dust filter,

FIG. 3 schematically shows multiple plant parts, the associated control units, and their interconnection to the computing unit,

FIG. 4 is a table showing several operating states of a plant part,

FIG. 5 shows a flow chart,

FIG. 6 shows a further flow chart,

FIG. 7 shows a time diagram, and

FIG. 8 shows a flow chart.

### DESCRIPTION OF EMBODIMENTS

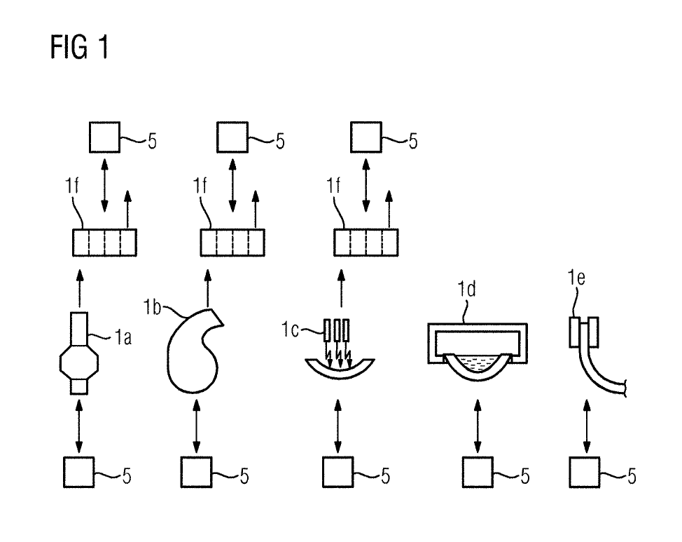

According to FIG. 1, a metallurgical plant comprises a plurality of plant parts 1. For example, the metallurgical plant may include a blast furnace 1a, a converter 1b, an electric arc furnace 1c, a vacuum treatment plant 1d, and/or a continuous casting plant 1e. The plant parts 1 interact. In this way, for example, pig iron produced in the blast furnace 1a is fed to the converter 1b and, there is converted into steel. Steel produced in the converter 1b or in the electric arc furnace 1c is fed to the vacuum treatment plant 1d, where it is metallurgically treated. The steel is then fed to the continuous casting plant 1e, in which said steel is cast into a continuous slab of steel. The plant parts 1 represented in FIG. 1 are intended only as examples. It is also possible for other or additional plant parts 1 to be present.

Insofar as the plant parts 1 and their operating modes are discussed only generally in the following, the generic reference sign 1 is used for the plant parts. Insofar as reference is made specifically to certain plant parts 1, the reference sign supplemented with the particular lowercase letter is specifically used, for example the reference sign 1c in the case of the electric arc furnace.

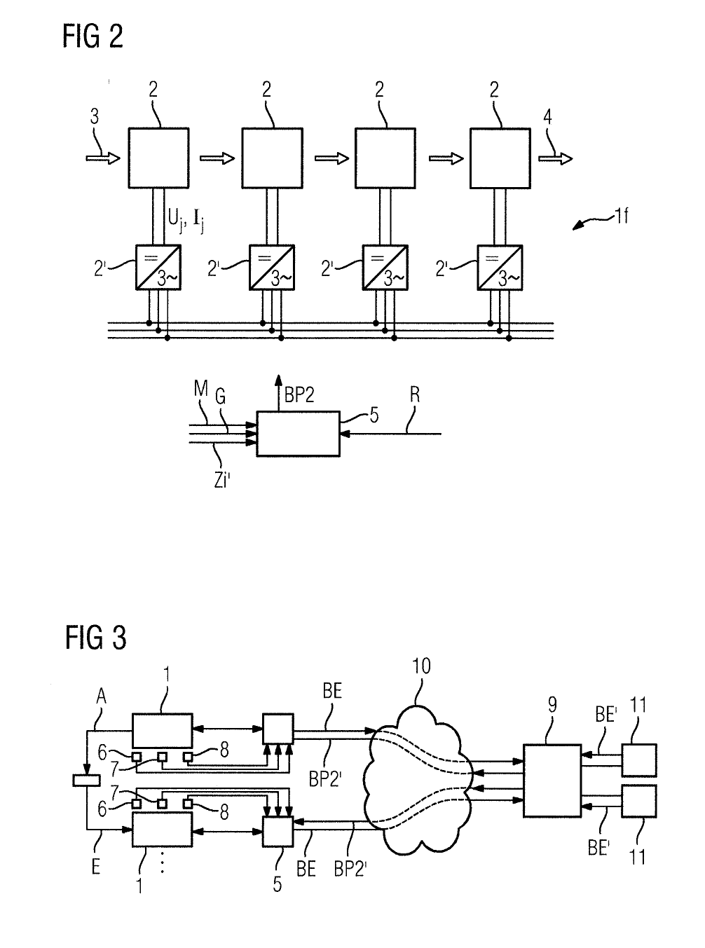

In addition, located downstream from many of the plant parts 1, in particular the blast furnace 1a, the converter 1b, and the electric arc furnace 1c, and, under certain circumstances, other plant parts 1—is an electrostatic dust filter 1f. The electrostatic dust filters 1f are also plant parts 1 within the meaning of the present invention. According to FIG. 2, the dust filters 1f include several filter chambers 2. The filter chambers 2 are connected in succession. Dust-laden exhaust gas is fed to the particular dust filter 1f. The dust-laden exhaust gas 3 fed through the successive filter chambers 2 sequentially, is further and further dedusted, until it is finally given off as purified exhaust gas 4. The gas is generally given off into the surroundings. The design and the operating principle of an electrostatic dust filter are generally known to experts and therefore need not be explained in greater detail.

The filter chambers 2 are supplied with electric energy via respective power supply units 2′, with a particular operating voltage Uj (j=1, 2, . . . ) and a particular operating current Ij. The power supply units 2′ are generally designed as indirect a.c. converters comprising a downstream high voltage transformer and rectifiers downstream therefrom.

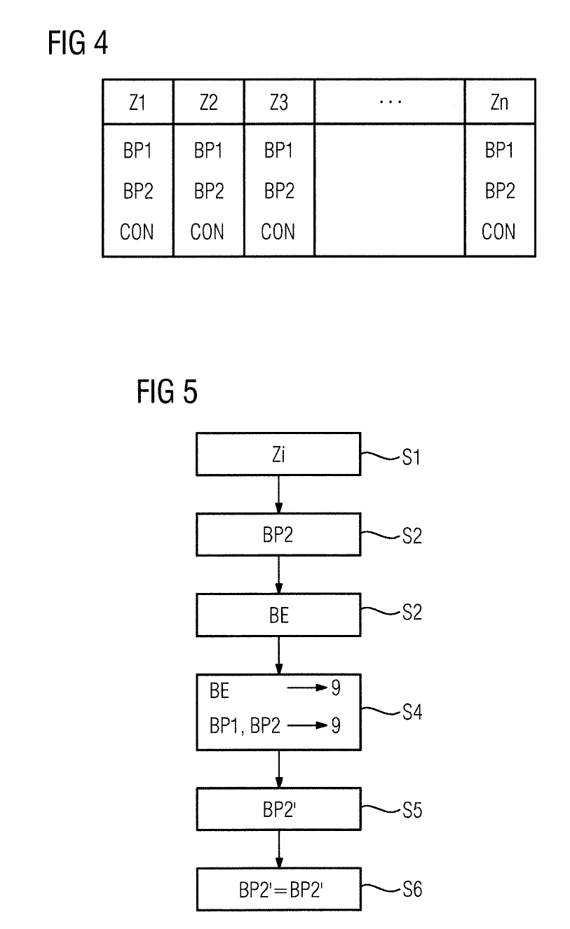

The plant parts 1 are controlled by a particular control unit 5 according to FIGS. 1 to 3. In particular, the plant parts 1 are generally operated by the particular control unit 5 in succession in a series of operating states Zi (i=1, 2, 3, . . . ). According to FIG. 4, each operating state Zi is defined by particular first operating parameters BP1, second operating parameters BP2, and a state condition CON. The list of operating states Zi is stored within the particular control unit 5 as a concatenated or unconcatenated list. The terms “first operating parameters” and “second operating parameters” are used in the generic sense. Alternatively, these can be individual values or groups of values.

The particular first operating parameters BP1 cannot be changed or adjusted by the particular control unit 5. These parameters are set from the outside, i.e., without assistance from the particular control unit 5. A converter 1b can have as a first parameter, for example, the quantity of pig iron filled into the converter 1b. An electric arc furnace 1c can have as a first parameter, for example, the quantity of scrap metal filled into the electric arc furnace 1c. A vacuum treatment plant 1d can have as a first parameter, for example, the quantity and the temperature of the steel filled into the vacuum treatment plant 1d. A continuous casting plant 1e can have as a first parameter, for example, the casting format. An electrostatic dust filter 1f can be, for example, the volumetric flow M and/or the extent of loading G of the dust-laden exhaust gas 3 fed to the electrostatic dust filter 1f. Alternatively, in the case of an electrostatic dust filter 1f, the first operating parameter BP1 can be the operating state Zi′ of an assembly 1a through 1d located upstream from the electrostatic dust filter 1f. This operating state Zi′ can be, but need not be, specified in as much detail as the operating state Zi.

Under certain circumstances, it suffices to specify the operating state Zi of the upstream assembly per se, i.e., for example, that a converter 1b is in a blowing phase, without specifying the operating parameters of the blowing phase in detail.

The particular second operating parameters BP2 can be set by the particular control unit 5. A converter 1b can have as a second parameter, for example, the duration and the intensity with which oxygen is blown onto the molten mass located in the converter 1b. An electric arc furnace 1c can have as a second parameter, for example, the positioning of the electrodes of the electric arc furnace 1c and their operating currents or operating voltages. A vacuum treatment plant 1d can have as a second parameter, for example, the quantity of additives filled into the vacuum treatment plant 1d. A continuous casting plant 1e can have as a second parameter, for example, the casting speed. An electrostatic dust filter if can have as a second parameter, for example, the electrical quantities Uj, Ij of the individual filter chambers 2 of the electrostatic dust filter 1f, in particular the operating voltages Uj or operating currents Ij. The second operating parameters BP2 can also be operating parameters in the further sense, for example, the parametrization of a controller, via which a setpoint value is converted into a controlled variable that influences the operation of the particular plant part 1.

In order to set the particular second operating parameters BP2, the particular control unit 5 according to FIG. 5 initially determines the particular operating state Zi in a step S1. The control unit then determines the second operating parameters BP2 assigned to this operating state Zi and controls the particular plant part 1 accordingly.

A particular operating result BE is established on the basis of the operation of the particular first plant part 1. A blast furnace 1a can be, for example, the quantity of pig iron produced, and its temperature. A converter 1b and an electric arc furnace 1c can be the quantity of steel produced, and its temperature. A vacuum treatment plant 1d can be, for example, the chemical composition of the steel when the steel leaves the vacuum treatment plant 1d. A dust filter 1f can be, in particular, the purity level R of the purified exhaust gas 4. The particular operating result BE is recorded by means of suitable sensors 6 in a manner known per se, and is fed to the particular control unit 5. The control unit 5 receives the particular operating result BE according to FIG. 5 in a step S3. The term “operating results” is used in the generic sense, similarly to the terms “first operating parameters” and “second operating parameters”. Alternatively, these can be individual values or groups of values in each case.

It is possible that the particular first operating parameters BP1 are also measured by the particular control unit 5 by means of suitable sensors 7. Alternatively, it is possible that the particular first operating parameters BP1 of the particular control unit 5 are known in another way. Whether the particular first operating parameters BP1 of the particular control unit 5 are known in one way or another is of minor significance within the scope of the present invention. It is also possible that the particular second operating parameters BP2 (more specifically: their actual values) are also measured by the particular control unit 5 by means of suitable sensors 8. Alternatively, it is possible that the particular second operating parameters BP2 are known per se to the particular control unit 5 due to the state Zi.

The particular control unit 5 transmits at least the particular operating result BE of the particular plant part 1 to a computing unit 9 in a step S4. Preferably, the particular control unit 5 also transmits at least the particular second operating parameters BP2 to the computing unit 9 within the scope of the step S4. If necessary, the particular control unit 5 can also transmit the particular first operating parameters BP1 to the computing unit 9 within the scope of the step S4.

According to FIG. 3, the transmission of the particular operating result BE (and, optionally, the first and/or second operating parameters BP1, BP2) takes place via a non-proprietary universal data link 10. The data link 10 can be, for example, a LAN, a WLAN, a telephone mobile communication network, or the Internet. It is decisive that the hardware structure of the data link 10 is not designed specifically for the communication between the particular control unit 5 and the computing unit 3, but rather is present anyway and can be utilized by many other participants and, in fact, is generally used.

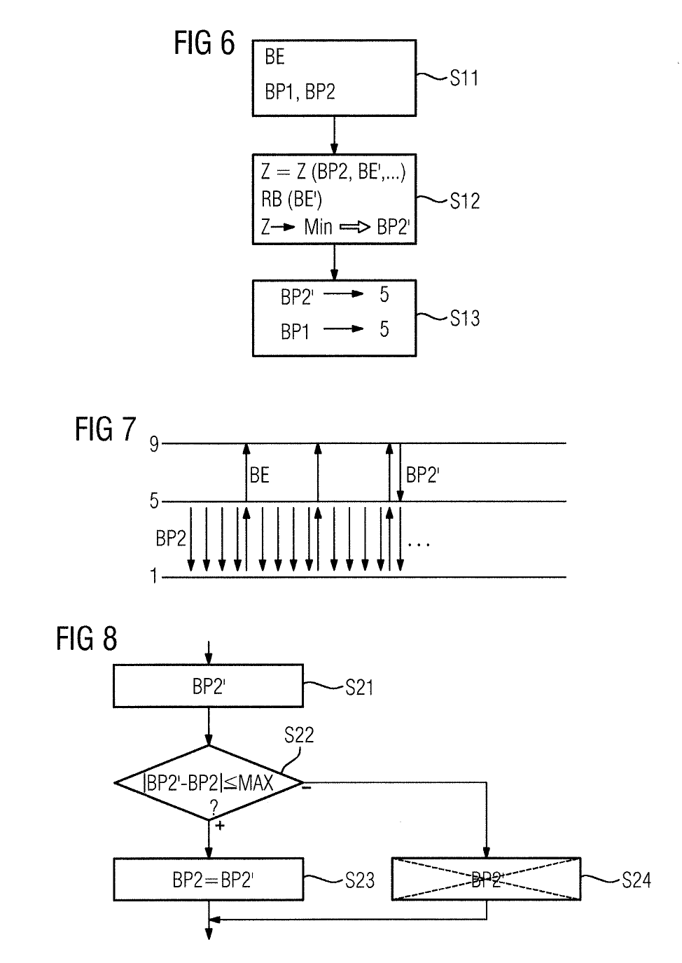

According to FIG. 6, the computing unit 9 receives the operating result BE (and, optionally, the associated first and/or second operating parameters BP1, BP2) transmitted from the particular control unit 5 to the computing unit, in a step S11. If the first and/or the second operating parameters BP1, BP2 are known a priori to the computing unit 9, the transmission of the corresponding operating parameters BP1, BP2 can be dispensed with, of course.

In a step S12, the computing unit 9 varies the second operating parameters BP2 (but not the first operating parameters BP1, of course) for the corresponding operating state Zi of the corresponding plant part 1. The computing unit thereby determines the varied second operating parameters BP2′ assigned to the first operating parameters BP1 of this operating state Zi.

Within the scope of the step S12, the computing unit 9 generally feeds the first operating parameters BP1 and the second operating parameters BP2 or the varied second operating parameters BP2′ to a model 11 (see FIG. 3) of the particular plant part 1. By means of the model 11, the computing unit 9 therefore determines an expected operating result BE′. By varying the second operating parameters BP2 and by determining the particular associated expected operating result BE′ in each case, the computing unit 9 can therefore determine optimized second operating parameters BP2′. The computing unit 9 therefore determines the varied second operating parameters BP2′ on the basis of the model 11 of the particular first plant part 1 with consideration for the first operating parameters BP1 and/or the second operating parameters BP2, BP2′ and the (expected) operating result BE′.

Within the scope of the implementation of the step S12, the computing unit 9 generally applies at least the second operating parameters BP2, BP2′ in a cost function Z. The term “cost function” is generally known to experts in the field of mathematical optimization. Within the scope of the step S12, the computing unit 9 then varies the second operating parameters BP2 and thereby determines the varied second operating parameters BP2′ at which the optimum of the cost function Z is reached.

It is possible that the computing unit 9 also applies the expected operating result BE′ in the cost function Z. This is useful, in particular, when an optimal value for the operating result BE in fact exists, but deviations from this optimal value are permissible within certain limits. Alternatively or additionally, it is possible that the computing unit 9 accounts for constraints RB that must be met for the operating result BE, within the scope of the optimization of the cost function Z. For example, it can be required that the operating result BE does not fall below a minimally permissible value, does not exceed a maximally permissible value, or lies between a minimally permissible value and a maximally permissible value.

The varied second operating parameters BP2′ determined by the computing unit 9 are transmitted by the computing unit, in a step S13, back to the control unit 5 of the corresponding plant part 1.

Optionally, the associated first operating parameters BP1 can also be transmitted, in addition. The transmission of the varied second operating parameters BP2′ (if necessary, including the associated first operating parameters BP1) from the computing unit 9 to the particular control unit 5 also takes place via the data link 10. It is also possible that the computing unit 9 internally stores the varied second operating parameters BP2′ it has determined, in addition to the transmission thereof to the corresponding control unit 5.

The corresponding control unit 5 receives the varied second operating parameters BP2′ (optionally including the associated first operating parameters BP1) in a step S5 (see FIG. 5). The control unit 5 of the corresponding first plant part 1 then updates the second operating parameters BP2 of the corresponding operating state Zi in a step S6. In particular, within the scope of the step S6, the control unit 5 can store the varied second operating parameters BP2′ instead of the previously stored second operating parameters BP2 of the corresponding operating state Zi in the list of operating states Zi. In the end, step S6 achieves that the control unit 5 of the corresponding first plant part 1 uses the associated varied second operating parameters BP2′, after the transmission of the varied second operating parameters BP2′, when the first operating parameters BP1 of the corresponding operating state Zi are established.

The output of the second operating parameters BP2 to the controlled elements of the particular plant part 1 generally takes place with a control pulse, according to the representation in FIG. 7. The control pulse generally lies in the range of a few milliseconds, even if the duration of the particular operating state Zi often lies in the minute range. In exceptional cases, the control pulse can also lie within the range of up to one second or slightly higher. Depending on the plant part 1 and depending on the operating result BE, the recording can also take place with the control pulse. Alternatively, the recording of the operating result BE can take place with a whole-number multiple of the control pulse. In the individual case, it is even possible that the recording of the operating result BE takes place only at the end of the particular operating state Zi.

Within the scope of the procedure according to the invention, it is possible to transmit only a few of the detected operating results BE to the computing unit. Preferably, however, according to the representation in FIG. 7, the entire sequence of the recorded operating results BE is transmitted to the computing unit 9.

The transmission of the varied second operating parameters BP2′ (if necessary, including the associated first operating parameters BP1) from the computing unit 9 to the particular control unit 5 generally takes place in a longer time interval. The time interval between each re-transmission of the varied second operating parameters BP2′ can be between several hours and several months, in particular. For example, the time interval can be between 2 days and 30 days. In the case of an electrostatic dust filter lf, in particular, although also in the case of another first plant part, in particular, the time interval can be, particularly preferably, between 5 days and 10 days, in particular 6 days to 8 days.

It is possible that the data link 10 between the particular control unit 5 and the computing unit 9 is not permanently established. For example, the data link 10 can be configured in advance only at certain points in time or, for example, can be interrupted as a result of interferences. Provided that a continuous transmission of the operating result BE is not possible, the particular control unit 5 of the corresponding first plant part 1 therefore buffers the recorded operating results BE. If necessary, the same procedure is also utilized for the associated first and/or second operating parameters BP1, BP2. The buffering is retained until a transmission to the computing unit 9 takes place.

FIG. 8 shows one possible implementation of the steps S5 and S6 of FIG. 5. According to FIG. 8, in a step S21, the control unit 5 of the particular plant part 1 initially receives varied second operating parameters BP2′ transmitted thereto, similarly to the buffering of the operating results BE. As a result, it can be ensured, in particular, that the second operating parameters BP2′ are transmitted completely to the particular control unit 5. Inconsistencies can be avoided as a result. Preferably, the control unit 5 of the particular first plant part 1 also checks the buffered second operating parameters BP2′ for plausibility, in a step S22. According to the representation in FIG. 8, the check can consist, in particular, in that a check is carried out to determine whether a deviation of the buffered second operating parameters BP2′ from the (previously valid) second operating parameters BP2 lies within a predefined boundary MAX. Provided that the buffered second operating parameters BP2′ pass the plausibility check carried out in step S22, the control unit 5 of the particular first plant part 1 applies the buffered second operating parameters BP2′ as new second operating parameters BP2, in a step S23. Otherwise, the control unit 5 discards the buffered second operating parameters BP2′, in a step S24.

As mentioned at the outset, the metallurgical plant comprises several plant parts 1, wherein the different plant parts 1 can be coupled to one another. The above-described procedure according to the invention can also be carried out individually for each plant part 1, of course, i.e., separated from the other plant parts 1. In particular, the operating mode can be carried out in parallel for several plant parts 1, according to the representation in FIG. 3. This is represented in FIG. 3 for two plant parts 1. The control units 5 of the different plant parts 1 are units that differ from one another. The computing unit 9 for determining the varied second operating parameters BP2′ can also be customized for the particular plant part 1, in principle.

Preferably, however, the computing unit 9 is identical for the two plant parts 1. This is the same computing unit 9. It is always possible to individually determine the varied second operating parameters BP2′. If the two plant parts 1 are coupled to one another, however, as represented in FIG. 3, in such a way that an output product A of the one plant part 1 is an input product E of the other plant part 1, and, in addition, the computing unit 9 for the two plant parts 1 is the same computing unit 9, the computing unit 9 can carry out, in particular, a combined optimization of the second operating parameters BP2′ for both plant parts 1. This procedure can also be expanded to more than two plant parts 1.

In summary, the present invention therefore relates to the following substantive matter:

A metallurgical plant comprises at least one plant part 1. The plant part 1 is operated with the aid of first and second operating parameters BP1, BP2 at a certain point in time. An operating result BE is established on the basis of the operation of the plant part 1 according to the first and second operating parameters BP1, BP2. The operating result BE is recorded. At least the operating result BE is transmitted from a control unit 5 of the first plant part 1 to a computing unit 9. The computing unit 9 varies the second operating parameters BP2, but not the first operating parameters BP1, and thereby determines varied second operating parameters BP2′ associated with the first operating parameters BP1. The computing unit 9 transmits the varied second operating parameters BP2′ back to the control unit 5 of the first plant part 1. The control unit 5 of the first plant part 1 uses the varied second operating parameters BP2′, after the transmission of the varied second operating parameters BP2′, when the first operating parameters BP1 are established.

The present invention has several advantages. In particular, an operation of the different plant parts 1 of the metallurgical plant, which has been optimized as necessary, can always be ensured. In addition, the operation of the plant parts 1 operated according to the invention can always be adapted to changed production or market conditions. Any other variable conditions, for example, the weather, can also be taken into account, as necessary. Algorithms for determining the varied second operating parameters BP2′ can always be adapted and updated as necessary. A cross-plant part optimization is also always possible. It is even possible to incorporate experiences based on the plant parts of another metallurgical plant into the determination of the varied second operating parameters BP2′.

Although the invention was illustrated and described in greater detail by means of the preferred exemplary embodiment, the invention is not restricted by the disclosed examples, and other variations can be derived therefrom by a person skilled in the art, without departing from the scope of protection of the invention.

### List of Reference Numbers

1 plant parts
1a to 1f specific plant parts
2 filter chambers
2′ power supply units
3 dust-laden exhaust gas
4 purified exhaust gas
5 control units
6 to 8 sensors
9 computing unit
10 data link
11 model of a plant part
A output product
BE, BE′ operating result
BP1 first operating parameters
BP2, BP2′ second operating parameters
CON state condition
E input product
G extent of loading
Ij operating currents
M volumetric flow
MAX predefined boundary
R purity level
RB constraints
S1 to S24 steps
Uj operating voltages
Z cost function
Zi, Zi′ operating states

1. An operating method for a metallurgical plant, the plant comprising:
at least one first plant part;
a control unit in which a plurality of operating states (Zi) of the first plant part are stored as a concatenated or unconcatenated list; and
a particular operating state (Zi) is defined by particular first operating parameters (BP1), second operating parameters (BP2), and a state condition (CON) operating state;
the method comprising:
operating the first plant part in a sequence of operating states (Zi) of the first plant part in succession;
adjusting the first operating parameters (BP1) without assistance from the control unit of the first plant part;
by the control unit of the first plant part, initially determining the particular operating state (Zi), of the first part and then controlling the first plant part according to the second operating parameters (BP2) assigned to the determined operating state (Zi);
establishing an operating result (BE) based on operation of the first plant part according to the first and second operating parameters (BP1, BP2), and recording the operating result;
transmitting at least the operating result (BE) from the control unit of the first plant part to a computing unit;
by the computing unit varying the second operating parameters (BP2), but not the first operating parameters (BP1), and thereby determining varied second operating parameters (BP2′) associated with the first operating parameters (BP1);
by the computing unit, transmitting the varied second operating parameters (BP2′) back to the control unit of the first plant part; and
by the control unit of the first plant part storing the varied second operating parameters (BP2′) instead of the previously stored second operating parameters (BP) of the corresponding operating state (Zi) in the list of operating states (Zi), and the control unit using the first plant part and using the varied second operating parameters (BP2′), after the transmission of the varied second operating parameters (BP2′), when the first operating parameters (BP1) are established.

2. The operating method as claimed in claim 1, further comprising:
by the computing unit, determining the varied second operating parameters (BP2′) on the basis of a model of the first plant part, while considering the first operating parameters (BP1) and/or the second operating parameters (BP2) and the operating result (BE).

3. The operating method as claimed in claim 2, further comprising:
at least one of the first operating parameters (BP1) and the second operating parameters (BP2) are a priori known to the computing unit, or transmitting at least one of the first operating parameters (BP 1) and the second operating parameters (BP2) from the control unit of the first plant part to the computing unit.

4. The operating method as claimed in claim 3, further comprising:
the computing unit applying at least the second operating parameters (BP2) in a cost function (Z) and determining the varied second operating parameters (BP2′) by an optimum of the cost function (Z) being reached with respect to the varied second operating parameters (BP2′), the computing unit further applying the first and second operating parameters (BP1, BP2) in the model and determining an associated expected operating result (BE′), and, within the scope of optimizing the cost function (Z), at least one of accounting by the computing unit for constraints (RB) to be met for the operating result (BE) applying the expected operating result (BE′) in the cost function (Z).

5. The operating method as claimed in claim 1, further comprising:
by the control unit of the first plant part, buffering the recorded operating results (BE) and, optionally, the first and second operating parameters (BE1, BE2), until there is a transmission to the computing unit.

6. The operating method as claimed in claim 5, further comprising:
the control unit of the first plant part initially receiving varied second operating parameters (BP2′) transmitted thereto and the control unit buffering the parameters.

7. The operating method as claimed in claim 6, further comprising by the control unit the first plant part, checking the buffered second operating parameters (BP2′) for plausibility, and by the control unit of the first plant part, applying the buffered second operating parameters (BP2′) as new second operating parameters (BP2) if the buffered second operating parameters (BP2′) pass the plausibility check, and otherwise discarding the buffered second operating parameters (BP2′).

8. The operating method as claimed in claim 7, further comprising the plausibility check consists of checking to determine whether a deviation of the buffered second operating parameters (BP2′) from the second operating parameters (BP2) lies within a predefined boundary (MAX).

9. The operating method as claimed in claim 1, further comprising transmitting the entire sequence of the recorded operating results (BE) to the computing unit.

10. The operating method as claimed claim 1, further comprising:
the control unit outputting the particular current second operating parameters (BP2) to controlled elements of the first plant part, with a control pulse in each case, and the control unit of the first plant part, recording at least the operating result (BE) with the control pulse or a whole-number multiple of the control pulse.

11. The operating method as claimed in of claim 1, further comprising continuously transmitting the operating results (BE) and, optionally if necessary, also the first and/or second operating parameters (BP1, BP2) to the computing unit, and in a longer time interval, transmitting the varied second operating parameters (BP2′) to the control unit of the first plant part.

12. The operating method as claimed in claim 11, further comprising the time interval between each re-transmission of the varied second operating parameters (BP2′) is between several hours and several months.

13. The operating method as claimed in claim 1, further comprising communicating the control unit of the first plant part and the computing unit with one another via a non-proprietary universal data link.

14. The operating method as claimed in claim 1, further comprising the first plant part is an electrostatic dust filter comprising several successively connected filter chambers,
the method comprising:
feeding a dust-laden exhaust gas to the electrostatic dust filter, dedusting the gas in the filter chamber and the electrostatic dust filter giving off the dedusted gas as purified exhaust gas;
the first operating parameter (BP1) is either the operating state (Zi′) of an assembly of operating parts upstream from the electrostatic dust filter or a volumetric flow (M) and/or an extent of loading (G) of the dust-laden exhaust gas fed to the electrostatic dust filter;
the second operating parameters (BP2) are electrical quantities of the individual filter chambers of the electrostatic dust filter; and
the operating result (BE) is the purity level (R) of the purified exhaust gas.

15. The operating method as claimed in claim 1, further comprising:
also performing the operating method for a second plant part of the metallurgical plant, wherein the first and the second plant parts are coupled to each other in such a way that an output product (A) of the first plant part is an input product (E) of the second plant part, the control unit of the second plant part is a different unit than the control unit of the first plant part, and the computing unit for determining the varied second operating parameters (BP2′) for the first plant part is identical to the computing unit for determining the varied second operating parameters (BP2′) for the second plant part.
